(19) United States
(12) Patent Application Publication
(10) Pub. No.: US 2026/0313381 A1
(43) Pub. Date: Oct. 8, 2026

(54) METHOD AND SYSTEM FOR GENERATIVE ARTIFICIAL INTELLIGENCE (GEN AI)-BASED SOFTWARE/HARDWARE LIFECYCLE MANAGEMENT

(71) Applicant: AT&T Intellectual Property I, L.P., Atlanta, GA (US)

(72) Inventors: Vivek Rajasekharan, Plano, TX (US); Lou Topfl, ATLANTA, GA (US); Tzvi Chumash, Matawan, NJ (US)

(73) Assignee: AT&T Intellectual Property I, L.P., Atlanta, GA (US)

(21) Appl. No.: 19/098,120

(22) Filed: Apr. 2, 2025

(51) Int. Cl. H04W 12/122

(52) U.S. Cl. CPC H04W 12/122

(57) ABSTRACT

Aspects of the subject disclosure may include, for example, obtaining initial information regarding at least one product, storing the initial information in a data structure, utilizing at least one AI model to generate first data for supplementing the initial information in the data structure, conducting automated data extractions from web-based content to obtain second data for further supplementing the initial information in the data structure, determining an update timeframe for performing additional automated data extractions from web-based content to obtain additional data relating to the at least one product, conducting the additional automated data extractions from web-based content based on the update timeframe to obtain the additional data relating to the at least one product, and based on the additional data, performing one or more actions with respect to the data structure or one or more systems associated with the at least one product. Other embodiments are disclosed.

### FIELD OF THE DISCLOSURE

The subject disclosure relates to methods and systems for generative artificial intelligence (Gen AI)-based software/hardware lifecycle management.

### BACKGROUND

In enterprise environments, managing a vast array of software/hardware licenses and vendor contracts is a complex and labor-intensive task. Project managers are tasked with manually entering and updating license information into databases whenever contracts are signed or amended. This manual process often leads to outdated and inaccurate database entries, which presents several challenges. Data staleness is a primary concern, as applications evolve and the information in the database becomes obsolete, which can complicate the decision-making process. The inefficiency of manual data entry is another issue, as it is both time-consuming and susceptible to human error. This inefficiency hampers the ability to make strategic decisions regarding new purchases and the understanding of existing assets. Moreover, the lack of real-time updates makes it difficult to stay informed about competitors'products and services that could serve similar functions. This gap in market awareness can lead to missed opportunities for optimization and cost savings. In many cases, enterprises invest substantial amounts in applications each year without having the subject matter expertise to assess whether the costs align with the benefits and utilization of these applications. For instance, undue maintenance costs can be incurred from the use of legacy applications. There is thus a need for an effective approach to managing software/hardware lifecycles, including the potential replacement or sunsetting of expensive licenses.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B depicts an illustrative embodiment of a method in accordance with various aspects described herein.

FIG. 2C is a diagram of an example AI architecture, which may be used to facilitate training or pre-training of one or more AI models, including, for instance, large language models (LLMs), in accordance with various aspects described herein.

FIG. 2D is a diagram of an example transformer model, a portion or an entirety of which may serve as a functional building block of one or more LLMs, in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a Gen AI-based system (e.g., implemented in one or more AI agents) that is capable of facilitating dynamic management of software/hardware lifecycles. In exemplary embodiments, the management system may be configured to manage lifecycles by way of web scraping, Gen AI, and database population. As described in more detail below, the management system may utilizes database to store information regarding software/hardware products, utilize Gen AI to populate certain fields (e.g., product features, vendor details, etc.) in the database, perform LLM-assisted web scraping to populate other fields that are not within the knowledge base of the LLM, determine timeframes for updating the database, perform additional LLM-assisted web scraping at the scheduled update times to obtain updated product information and/or related data, detect any changes from the update process (e.g., service updates, sunsetting, competitor product improvements, news articles on one competitor's product being replaced or ousted by another competitor's product, etc.), and using LLM(s) to identify or flag anomalies and triggering alerts to stakeholders based on detected anomalies.

Exemplary embodiments of the Gen AI-based management system advantageously automate the management of software and hardware lifecycles by automating the update process and leveraging real-time data sources. By updating a product information database between contract amendments, such as when a product or service receives new features during an update or patch, the management system ensures that the database remains current and reflective of the latest product capabilities. The management system can also identify and address duplicate entries or outdated versions of applications that are installed in a network. Overall, the automation significantly reduces the manual effort that is otherwise required to maintain database accuracy, thereby reducing the potential for errors. The management system's ability to utilize real-time information from news sources and online platforms also allows an organization to take swift action and remain agile in a rapidly changing market environment. This capability ensures that any product improvements or issues are identified effortlessly, enabling proactive management and strategic decision-making. Furthermore, the management system can easily and automatically identify opportunities for product replacement with superior or more cost-effective alternatives.

From a network security standpoint, embodiments of the Gen AI-based management system may be capable of automatically detecting and responding to security vulnerabilities relating to a given product or service. For instance, if, through web scraping activities, a vulnerability is identified in a virtual network function (VNF) within a base station or the like, the management system can automatically trigger an update process—e.g., by causing a security patch from a vendor's server to be obtained and installed. This ensures that potential threats to the network are addressed quickly, which reduces the risk of security breaches and thus improves overall network security.

One or more aspects of the subject disclosure include a device, comprising a processing system including a processor, and a memory that stores executable instructions that, when executed by the processing system, facilitate performance of operations. The operations can include obtaining initial information regarding at least one product. Further, the operations can include storing the initial information in a data structure. Further, the operations can include utilizing at least one artificial intelligence (AI) model to generate first data for supplementing the initial information in the data structure. Further, the operations can include conducting automated data extractions from web-based content to obtain second data for further supplementing the initial information in the data structure. Further, the operations can include determining an update timeframe for performing additional automated data extractions from web-based content to obtain additional data relating to the at least one product. Further, the operations can include conducting the additional automated data extractions from web-based content based on the update timeframe to obtain the additional data relating to the at least one product. Further, the operations can include based on the additional data, performing one or more actions with respect to the data structure or with respect to one or more systems associated with the at least one product.

One or more aspects of the subject disclosure include a non-transitory machine-readable medium, comprising executable instructions that, when executed by a processing system including a processor, facilitate performance of operations. The operations can include receiving initial information regarding at least one product or service. Further, the operations can include storing the initial information in a data structure. Further, the operations can include utilizing at least one artificial intelligence (AI) model to generate first data for supplementing the initial information in the data structure. Further, the operations can include conducting automated data extractions from web-based content to obtain second data for further supplementing the initial information in the data structure. Further, the operations can include determining an update timeframe for performing additional automated data extractions from web-based content to obtain additional data relating to the at least one product or service. Further, the operations can include conducting the additional automated data extractions from web-based content based on the update timeframe to obtain the additional data relating to the at least one product or service. Further, the operations can include based on the additional data, performing one or more actions with respect to one or more systems associated with the at least one product or service.

One or more aspects of the subject disclosure include a method. The method can comprise utilizing, by a processing system including a processor, at least one artificial intelligence (AI) model to generate first data for supplementing initial information associated with at least one product or service. Further, the method can include conducting, by the processing system, automated data extractions from web-based content to obtain second data for further supplementing the initial information. Further, the method can include determining, by the processing system, an update timeframe for performing additional automated data extractions from web-based content to obtain additional data relating to the at least one product or service. Further, the method can include conducting, by the processing system, the additional automated data extractions from web-based content based on the update timeframe to obtain the additional data relating to the at least one product or service. Further, the method can include based on the additional data, performing, by the processing system, one or more actions with respect to one or more systems associated with the at least one product or service.

Other embodiments are described in the subject disclosure.

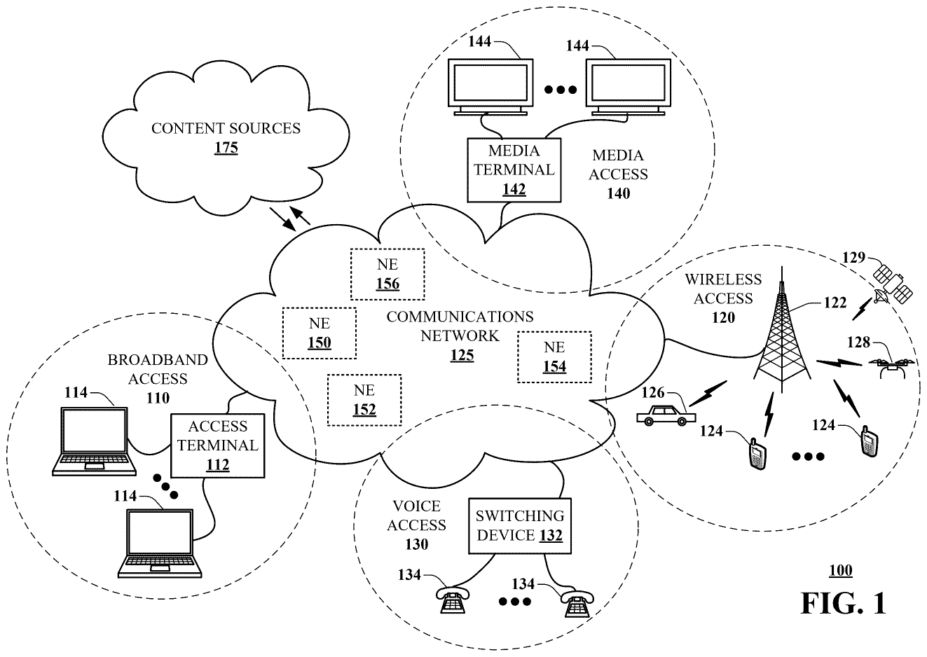

Referring now to FIG. 1, a block diagram is shown illustrating an example, non-limiting embodiment of a system 100 in accordance with various aspects described herein. For example, system 100 can facilitate, in whole or in part, Gen AI-based software/hardware lifecycle management. In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

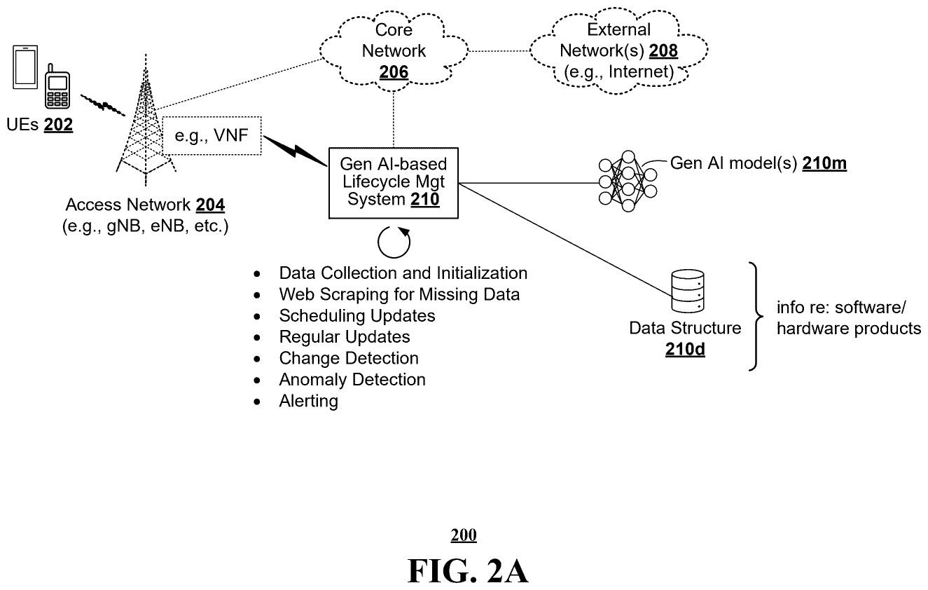

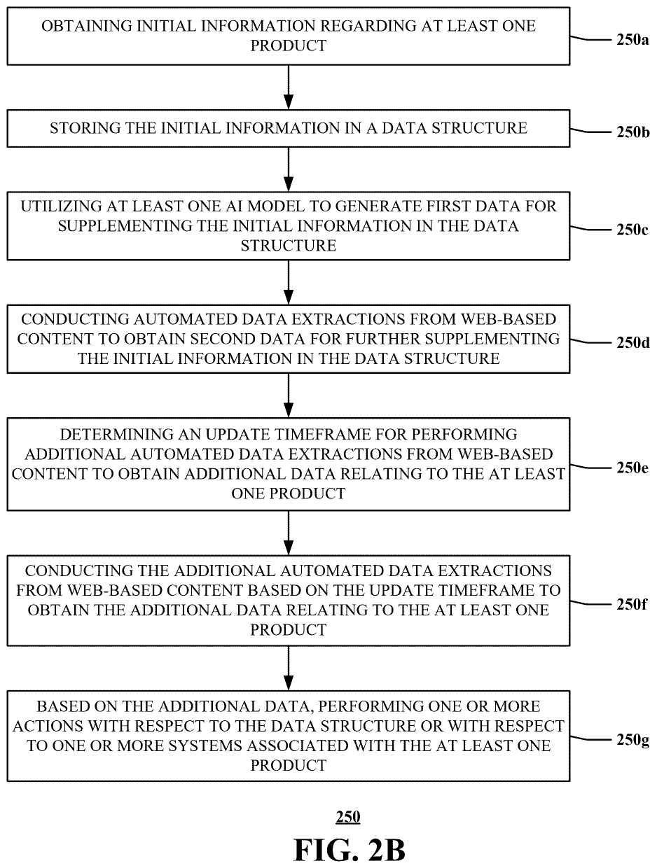

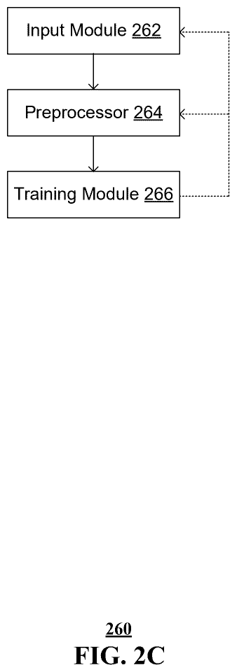

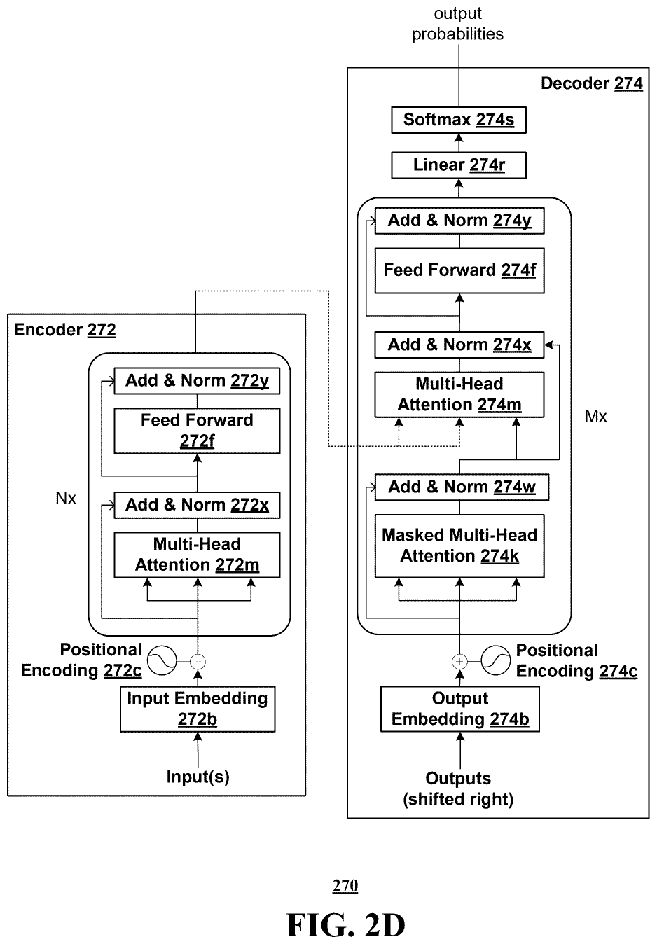

FIG. 2A illustrates an example network 200 in which a Gen AI-based lifecycle management system 210 facilitates software/hardware product lifecycle management. The network 200 may include an access network 204 and a core network 206 that are associated with a network operator.

The core network 206 may include network devices and/or systems that provide a variety of functions. In certain embodiments, the core network 206 may be implemented in a cloud architecture. Examples of functions provided by, or included, in the core network 206 include an access mobility function (AMF) configured to facilitate mobility management in a control plane of the network system (including, for instance, providing user equipment (UE) mobility information associated with one or more RANs and/or UEs 202 to the core network 206), a user plane function (UPF) configured to provide access to a data network, such as a packet data network (PDN), in a user (or data) plane of the network system, a Unified Data Management (UDM) function, a Session Management Function (SMF), a policy control function (PCF), and/or the like. The core network 206 may be in communication with external network(s) 208 (e.g., one or more content delivery networks (CDNs), the Internet, etc.), one or more services, and/or one or more other devices. In one or more embodiments, the core network 206 may include one or more devices implementing other functions, such as a master user database server device for network access management, a PDN gateway server device for facilitating access to a PDN, and/or the like. The core network 206 may include various physical/virtual resources, including server devices, virtual environments, databases, and so on.

The access network 204 may include a wireless RAN, a Wi-Fi network, and/or a wireline network, and may include network resources, such as one or more physical access resources and/or one or more virtual access resources. Physical access resources can include base station(s) (e.g., one or more eNodeBs, one or more gNodeBs, or the like), one or more satellites, one or more Gigabyte Passive Optical Networks (GPONs) or related components (e.g., Optical Line Terminal(s) (OLT), Optical Network Unit(s) (ONU), etc.), and/or the like. A given base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the RAN subsystem. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the RAN subsystem may include any number/types of physical/virtual access resources and various types of heterogeneous cell configurations with various quantities of cells and/or types of cells. In certain embodiments, the access network 204 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller.

In certain embodiments, the access network 204 may include one or more RAN intelligent controllers (RICs). Although not shown, a given RIC may include a first RIC portion implemented, or otherwise incorporated, in a network service management platform. The RIC may include a second RIC portion having a control or centralized unit (CU) (e.g., a base station CU, such as a gNodeB (gNB) CU or the like) that provides a CU applications layer as well as a CU control plane (CU-CP) and a CU user plane (CU-UP). In various embodiments, the first RIC portion may be configured to operate in non-real-time, and the second RIC portion may be configured to operate in near real-time. The particular functions performed by the two RIC portions can vary based on various criteria, including implementing changing parameters or requirements for the network, and can also include redundancy and/or dynamic switching of functions between the RIC portions. In various embodiments, the CU may interact with distributed units (DUs) that implement baseband units. In exemplary embodiments, each of one or more DUs may be implemented as a virtual DU (vDU). The DUs may respectively interact with remote radio heads or remote units (RUs). The RUs, the DUs, and the CU may, by way of fronthaul(s), midhaul(s), and backhaul(s), provide (e.g., controlled) connectivity between the core network 206 and the UEs 202. In various embodiments, the access network 204, including some or all of its components, may conform to open standards, such as Open Radio Access Network (O-RAN) standards or the like.

The UEs 202, whose users may be subscribers of the network operator, may utilize the access network 204 and the core network 206 to obtain access to the external network(s) 208. A given UE 202 may be any computing device that is capable of obtaining and/or processing data and communicating information with one or more other devices (e.g., over the network 200). As some non-limiting examples, a UE 202 may be a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a biometric sensor (e.g., for monitoring heart rate, blood pressure, pulse, breathing, etc.), an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a door/lock controller (e.g., for a room door, a garage door, etc.), a tracking device (e.g., for tracking objects on the road, in a factory/warehouse setting, etc.), a vehicle, a similar type of device, a different type of device, or a combination of some or all of these devices.

In one or more embodiments, the management system 210 may be implemented in hardware, firmware, or a combination of hardware and software. In various embodiments, the management system 210 may facilitate automated management of the lifecycles of products (e.g., that may be utilized by an entity, such as an organization or the like) by leveraging web scraping, Gen AI, and database population. This ensures that product/vendor details are kept up-to-date either in real-time (or near real-time) or at specified intervals, which can enhance operational efficiency and decision-making. Additionally, security patching and/or threat information may also be kept up-to-date in real-time (or near real-time) to allow for swift alerts and responses. The management system 210 may operate automatically or independently—i.e., with little to no user input.

The management system 210 may have access to a data structure 210d, which may include one or more databases, arrays, linked lists, tables, trees, and/or the like that are configured to store information regarding the products. The products may include software products, such as virtual network functions (VNFs), network management systems, billing and customer relationship management (CRM) software, network security applications, traffic optimization tools, service orchestration platforms, network analytics software, and so on. The products may additionally, or alternatively, include hardware products, such as routers, switches, base station equipment, OLTs, remote radio heads (RRHs), network servers, edge computing devices, and so on. The products may additionally, or alternatively, include services that are provided by vendor systems/applications. The data structure 210d may be configured to store various product-related details, such as product/service name, version, vendor name, related uniform resource locator (URL), features or functionalities, purchase date, cost, license expiration date, maintenance schedule, a log of known issues or updates, patches, threats, vulnerabilities, etc.

In various embodiments, the management system 210 may leverage and/or include Gen AI model(s) 210m. In some embodiments, the Gen AI model(s) 210m may be at least partially implemented in the management system 210. In alternate embodiments, the Gen AI model(s) 210m may be implemented in distributed agents throughout components of the access network 204, components of the core network 206, and/or other systems/devices. In various embodiments, the Gen AI model(s) 210m may be trained via an AI architecture (e.g., an AI architecture 260 illustrated in FIG. 2C and described in more detail below). In certain embodiments, the Gen AI model(s) 210m may include one or more LLMs, one or more transformer-based models, one or more auto-regressive models, one or more of another type of Gen AI model, or a combination of some or all of these models. As an example, the Gen AI model(s) 210m may include one or more LLMs that are based on the transformer model 270 illustrated in FIG. 2D and described in more detail below.

The management system 210 may be configured to perform various functions. For the sake of simplicity, these functions are described with respect to an example process flow or workflow, but it is to be understood and appreciated that some or all of these functions may be performed with respect to other process flows or workflows.

The management system 210 may perform data collection and initialization. The management system 210 may, for instance, populate the data structure 210d with information regarding existing products. This initial information can come from various sources, such as user input, existing databases, or vendor catalogs. In some cases, a user may input just a few words or a product name along with some contractual terms, with little to no other information. The management system 210 may utilize the Gen AI model(s) 210m to fill in one or more fields of information, such as product features, vendor details, version history, compatibility requirements, maintenance schedules, etc. For instance, if the initial product information is simply the product name “Network Function X,” the management system 210 may use the Gen AI model(s) 210m to identify (e.g., from its training or knowledge base) the manufacturer, the latest firmware version, the primary features of the function, competing products, features of competing products, etc., and may input this identified information into the data structure entry associated with the product. This can provide for more completeness and accuracy in the product entries in the data structure 210d.

In various embodiments, the management system 210 may employ LLM-assisted web scraping to gather and populate (e.g., any) missing fields or additional fields that are not covered by the initial information or the training/knowledge base of the Gen AI model(s) 210m. This process may involve analyzing (or scrubbing) particular data, such as proprietary data or the like, and/or performing web scraping on search pages to gather potential targets. For example, the management system 210 may target specific industry websites or forums where detailed product specifications, user reviews, etc. are typically shared or discussed. The management system 210 may utilize the Gen AI model(s) 210m to identify one or more appropriate targets, such as the best web links to derive or obtain application feature information or competitive pricing information, and may scrape the identified target websites. As an example, where the product is a network switch, the management system 210 may identify and scrape data from a corresponding manufacturer's website, a technology review site, and/or a user forum where the switch is frequently discussed. The scraped information (which may include videos, audios, images, and/or text) may be fed into the Gen AI model(s) 210m to derive corresponding (e.g., text-based) information for populating relevant fields in the data structure 210d.

In certain embodiments, the management system 210 may perform automated competitor information retrieval by automatically discovering and analyzing competitor vendors that offer similar applications. For instance, the management system 210 may determine that, for Network Function X, there is a competing product Network Function Y that provides similar functionalities. The management system 210 may, for example, make this determination by analyzing product specifications, user reviews, and/or market reports to identify similarities in features and performance. This process may involve converting the features and attributes of Network Function X and Network Function Y into vector representations, where each feature or attribute, such as performance metrics, cost, and user ratings, can be encoded as a numerical value, resulting in a multi-dimensional vector for each network function. The management system 210 may then use these vectors to perform a comparison. The comparison can be conducted using techniques, such as cosine similarity, which measures the cosine of the angle between two vectors in a multi-dimensional space. A cosine similarity score that is close to 1 may indicate that the vectors are similar, suggesting that the network functions have similar features and performance. The management system 210 may also apply a threshold to determine if the similarity is significant enough to consider the functions as competing functions. The management system 210 can also extract features as phrases or words that can make up or represent the functionality of a given product. If there is a change in requirements where certain features are no longer utilized, and a cheaper competitor product is available with fewer features, the management system 210 can flag this for further analysis and potential action by decision-makers. Where the management system 210 identifies that a new competitor product offers better performance at a lower cost, the management system 210 can similarly flag this for further analysis and potential action by decision-makers. This aids in the discovery of more cost-effective or superior alternatives, which enhances strategic decision-making.

The management system 210 may determine an appropriate update frequency—real-time, hourly, daily, weekly, monthly, yearly, etc.—for updating the database with the latest information that is available on software/hardware products. In some embodiments, the update frequency may be based on determined technological advancement rates, such as a historical or predetermined rate of change or update in software/hardware versions or features over time—e.g., improved firmware may generally be released every twelve months, software patches may generally be released every three months, etc. The update frequency can be different for different columns within the database.

The management system 210 can be configured to monitor for specific triggers or thresholds, such as the release of new versions or updates from vendors, changes in competitor offerings, or significant shifts in market trends. For instance, the management system 210 may subscribe to identified feeds (e.g., web sites, blogs, e-mail notification systems, video reviews, etc.) that report on updates to software/hardware, such as critical security patches, or that report on the latest products in a given technological area (which can include new competitor products). The management system 210 may learn about an upcoming update—e.g., a release date or an announcement—from previous web scraping activities. For example, if the management system 210 scrapes a vendor's website and identifies a reported upcoming release date for a new software version of a given product, the management system 210 may set an internal timer to perform an update check on that date.

In any case, updates may be scheduled based on the determined update frequency. At these scheduled intervals, the management system 210 may perform LLM-assisted web scraping to update the data structure 210d with any new or updated information that is found. This ensures that the data structure 210d remains comprehensive and up-to-date by tracking changes or new events, such as service updates, sunsetting of products, and/or competitor product improvements.

During an update process for a product (e.g., each product) in the database, the management system 210 may perform change/anomaly detection by identifying updates, such as service enhancements, sunsetting of products, competitor improvements, news articles suggesting product replacements, new discounts, etc. For example, the management system 210 may detect a change based on an identified release of a new version of a product with enhanced features or based on a discovered product discount that is offered by a vendor. As another example, if a competitor suddenly reduces the price of a similar product, the management system 210 can compare the current price scraped from the competitor's website with the price that is previously stored in the data structure 210d. If the current price is significantly lower (e.g., lower by more than a threshold amount), this discrepancy can be flagged as an anomaly for further follow-up. Similarly, if a news article indicates that a product is being discontinued, the management system 210 can alert decision-makers to consider alternative solutions. As yet another example, if the management system 210 determines that a product's recently-reported performance metrics (as reported by a technology blog, as reported by the vendor, and/or the like) deviate from current or historical metrics of the installed software/hardware (i.e., by greater than one or more threshold(s)), the management system 210 may flag this as an anomaly. As another example, the vendor company may be in negotiations to be acquired by a larger company, which, based on previously-identified trends (e.g., as identified by the management system 210), may result in price hikes. In this example, the management system 210 can identify this information from news articles to flag and track the potential acquisition and its timeframe to provide decision-makers with ample time to find alternatives. In all, this proactive approach ensures that the data structure 210d remains accurate and relevant for supporting strategic decision-making and maintaining a competitive edge. When changes or anomalies are detected, the management system 210 may flag these issues and send alerts to relevant stakeholders for prompt action.

Some or all of the functionalities of the management system 210 may involve generating prompts for the Gen AI model(s) 210m, accessing and retrieving data from (and/or inputting data into) the data structure 210d, and/or generating embedding vectors. For example, as part of data collection and initialization, the management system 210 may create and input initial information for a product into the data structure 210d. When populating fields for the product, the management system 210 may generate a prompt for the Gen AI model(s) 210m to generate additional information that is not included in the initial input. During the process of automated data extraction for missing data, the management system 210 may generate a prompt for the Gen AI model(s) 210m to obtain and identify further information from the web that is not part of the initial dataset. In the context of change/anomaly detection, the management system 210 may retrieve information from the data structure 210d, generate embedding vectors based on the retrieved data, convert newly-extracted information into vector embeddings, and perform comparisons to identify any discrepancies.

It will be understood and appreciated that the functionality of the management system 210 allows for a variety of use cases, including proactive lifecycle management, dynamic discount tracking, feature upgrade notifications, news and external data integration, etc.

For instance, the management system 210 can automatically detect when an application is being sunset and will lose support within a specific timeframe, such as in the next six months. This can be achieved by continuously monitoring vendor announcements, product roadmaps, support documentation, and/or the like. The management system 210 can parse this information using the Gen AI model(s) 210m to identify key dates and terms related to end-of-life or support termination.

As another example, the management system 210 can continuously monitor and track discounts that are offered by vendors. The management system 210 may scrape vendor websites, promotional emails, and/or industry forums to gather information on current and upcoming discounts. When new discounts are detected, the management system 210 can instantly alert stakeholders such that cost-saving opportunities are not missed. This real-time (or near real-time) alerting mechanism allows an organization to make informed purchasing decisions and improve budget allocations.

As yet another example, the management system 210 can detect for feature upgrades of both the company's products and competitor products. By analyzing product release notes, technical blogs, and/or user forums, the management system 210 can identify new features and enhancements, which can be cross-referenced with the company's existing product portfolio to highlight potential areas for improvement or competitive advantage.

As a further example, the management system 210 can identify when a product or vendor is featured in the news for any reason, such as outages or significant updates. For instance, if a major security breach is reported for a vendor's product, the management system 210 can alert the relevant internal teams to assess the impact and take necessary actions. This keeps the company informed and agile, which allows for prompt action and informed decision-making.

In some embodiments, where the management system 210 identifies vendor discounts through web scraping, the management system 210 may automatically initiate contact with the vendor to apply the discount to the relevant product. For example, if the management system 210 detects a promotional offer on a vendor's website, the management system 210 can automatically generate and transmit a request to the vendor (such as a vendor management/ordering system) to apply the discount to the organization's existing contract or purchase order. This process can be facilitated by integrating with the organization's procurement system to allow for seamless application of discounts and ensuring cost savings. The management system 210 can also track the expiration dates of discounts and send reminders to stakeholders to take timely action.

In certain embodiments, the management system 210 can integrate or communicatively couple with financial systems to automate vendor and competitor cost-benefit analyses. This integration allows the management system 210 to access financial data, such as purchase costs, maintenance expenses, and/or revenue impacts associated with various products and services. By leveraging this data, the management system 210 can perform detailed cost-benefit analyses to evaluate the financial viability of current vendor contracts and competitor offerings. For example, the management system 210 can compare the total cost of ownership of a current software solution with that of a competitor's offering, factoring in licensing fees, support costs, and potential revenue gains from enhanced features. This automated analysis enables decision-makers to make more informed choices about vendor relationships and potential product replacements.

In one or more embodiments, the management system 210 can integrate databases with machine learning (ML) models to forecast future trends in vendor products and services. The management system 210 can analyze current market data, technology reports, and/or advancements in the industry to predict upcoming trends. For instance, the management system 210 can monitor technology blogs, industry publications, patent filings, and/or the like to identify emerging technologies and innovations. By applying ML algorithms, the management system 210 can detect patterns and correlations in the data, allowing it to forecast the introduction of new vendor products or services. For example, if the management system 210 identifies a surge in research and development activities related to a specific technology, the management system 210 can predict the likelihood of a new product launch in that area.

In various embodiments, the management system 210 can integrate with security system(s) to automatically detect and respond to any security vulnerabilities related to vendor products or services. For instance, if, from web scraping activities, a vulnerability is identified in a VNF within a base station, the management system 210 can automatically trigger an update process. This may involve obtaining the necessary security patch from the vendor's server and initiating patching of the VNF software. In certain embodiments, the management system 210 can continuously monitor security advisories and/or threat intelligence feeds to preemptively address potential vulnerabilities. By leveraging machine learning algorithms, the system can prioritize vulnerabilities based on their severity and potential impact so as to ensure that critical issues are promptly addressed.

In exemplary embodiments, the management system 210 may detect anomalies in product performance, and trigger one or more actions, such as security patching, hardware setting adjustments, environmental ventilation control adjustments, and/or the like based on the detected anomalies. For instance, assume that, based on LLM-assisted web scraping, the management system 210 obtains a recently-reported performance metric of a VNF. The management system 210 may proactively obtain (e.g., from a network management system associated with the VNF) a current or historical performance metric of the VNF and compare it with the recent one. If the difference between the two values is greater than a predefined threshold (e.g., greater than a 10% deviation, a 20% deviation, or the like), the management system 210 may determine this as an anomaly, which can be indicative of a security flaw (e.g., security update needs to be performed), non-optimal settings (e.g., incorrect hardware settings for the software), operational environment inefficiencies (e.g., system overheating), and/or the like. The management system 210 can then command related systems to make certain adjustment(s). For instance, where the management system 210 determines the anomaly to be related to a security issue, the management system 210 may command a vendor server to provide a security patch for automatic patching of the VNF. As another example, the management system 210 can command a network device or board that executes or contains the VNF to adjust an operational setting thereof. As yet another example, the management system 210 can interface with a heating, ventilation, and cooling (HVAC) control system to decrease the temperature at a base station enclosure that houses the VNF. As an additional example, the management system 210 can dynamically turn on and/or off radios based on utilization, time of day, load, and/or other heuristics determined from data via machine learning or other methods. Additionally, or alternatively, the management system 210 can reallocate licenses among devices based on usage.

In various embodiments, the management system 210 may utilize an artificial neural network (ANN) to identify or detect anomalies. The ANN may be composed of a series of layers that each includes one or more neurons arranged in one or more neuron arrays. A neuron may be implemented in a register or a microprocessor, with at least one input. Each neuron may produce an output, or activation, based on an activation function that uses the outputs of a previous layer and a set of weights as inputs. Each neuron in a neuron array may be connected to another neuron via a synaptic circuit, which may include a memory for storing a synaptic weight. In one or more embodiments, the ANN may be a Deep Neural Network (DNN) that includes an input layer, an output layer, and multiple, connected hidden layers. In some embodiments, the ANN may be implemented in an application-specific integrated circuit (ASIC). In various embodiments, the ANN may be trained using training data that is generated by receiving continuous data (i.e., data that is measured and that can have any number of possible values) at a computing system, and using the computing system to discretize the continuous data. In some embodiments, the continuous data may be received remotely over a network. The continuous data may be historical data that the ANN can utilize to learn patterns to identify or detect potential anomalies. In certain embodiments, the training data may include discrete data in addition, or as an alternative, to continuous data. Discrete data is data that can be counted and that has a limited number of values. Discretization method(s)—e.g., binning, clustering, numerical discretization, etc.—may be used to convert continuous data to discrete data. The ANN may be trained using known training technique(s) (e.g., backpropagation, gradient descent, etc.), and can be utilized by the management system 210 to monitor web-scraped performance metrics to detect anomalies relative to current system performance metrics. If the ANN detects one or more anomalies, the ANN may additionally analyze the detected anomalies to generate anomaly data that can be output to a user and/or used to re-train the ANN. For example, the anomaly data may explain the type of anomaly or a cause of the anomaly.

In this way, the management system 210 advantageously enhances network security and operations by reducing the delays that would otherwise result from waiting on a network administrator to respond to security vulnerabilities or other operational errors or inefficiencies. By automatically obtaining and installing security patches for VNFs based on vulnerabilities identified through web scraping and ML algorithms, for instance, the management system 210 can ensure that critical issues are addressed swiftly, thereby maintaining the integrity and reliability of the network infrastructure without relying on manual intervention.

It is to be understood and appreciated that, although FIG. 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, networks, blocks, models, devices, etc. may have been illustrated in FIG. 2A as separate systems, networks, blocks, models, devices, etc., it will be appreciated that multiple systems, networks, blocks, models, devices, etc. can be implemented as a single system, network, block, model, device, etc., or a single system, network, block, model, device, etc. can be implemented as multiple systems, networks, blocks, models, devices, etc. Additionally, functions described as being performed by one system, network, block, model, device, etc. may be performed by multiple systems, networks, blocks, models, devices, etc., or functions described as being performed by multiple systems, networks, blocks, models, devices, etc. may be performed by a single system, network, block, model, device, etc.

FIG. 2B depicts an illustrative embodiment of a method 250 in accordance with various aspects described herein.

At 250a, the method can include obtaining initial information regarding at least one product. For example, the management system 210 can, similar to that described above with respect to the system 200 of FIG. 2A, perform one or more operations that include obtaining initial information regarding at least one product.

At 250b, the method can include storing the initial information in a data structure. For example, the management system 210 can, similar to that described above with respect to the system 200 of FIG. 2A, perform one or more operations that include storing the initial information in a data structure.

At 250c, the method can include utilizing at least one AI model to generate first data for supplementing the initial information in the data structure. For example, the management system 210 can, similar to that described above with respect to the system 200 of FIG. 2A, perform one or more operations that include utilizing at least one AI model to generate first data for supplementing the initial information in the data structure.

At 250d, the method can include conducting automated data extractions from web-based content to obtain second data for further supplementing the initial information in the data structure. For example, the management system 210 can, similar to that described above with respect to the system 200 of FIG. 2A, perform one or more operations that include conducting automated data extractions from web-based content to obtain second data for further supplementing the initial information in the data structure.

At 250e, the method can include determining an update timeframe for performing additional automated data extractions from web-based content to obtain additional data relating to the at least one product. For example, the management system 210 can, similar to that described above with respect to the system 200 of FIG. 2A, perform one or more operations that include determining an update timeframe for performing additional automated data extractions from web-based content to obtain additional data relating to the at least one product.

At 250f, the method can include conducting the additional automated data extractions from web-based content based on the update timeframe to obtain the additional data relating to the at least one product. For example, the management system 210 can, similar to that described above with respect to the system 200 of FIG. 2A, perform one or more operations that include conducting the additional automated data extractions from web-based content based on the update timeframe to obtain the additional data relating to the at least one product.

At 250g, the method can include based on the additional data, performing one or more actions with respect to the data structure or with respect to one or more systems associated with the at least one product. For example, the management system 210 can, similar to that described above with respect to the system 200 of FIG. 2A, perform one or more operations that include based on the additional data, performing one or more actions with respect to the data structure or with respect to one or more systems associated with the at least one product.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

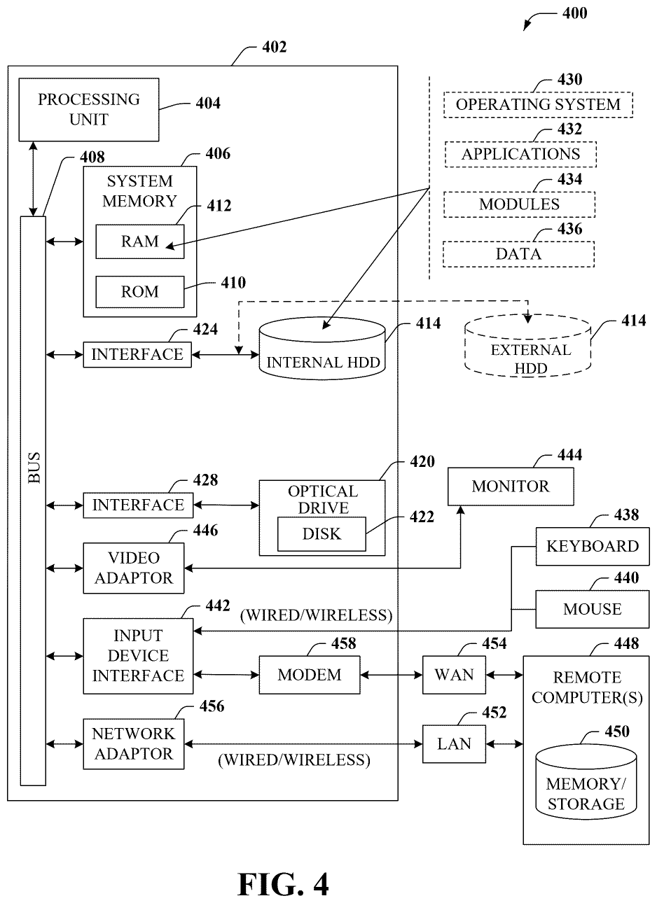

Referring to FIG. 2C, an example AI architecture 260 may be used to facilitate training and/or pre-training of AI models, such as Gen AI model(s) 210m described above with respect to one or more of FIGS. 2A and 2B. For instance, the AI architecture 260 may be used to facilitate training and/or pre-training of an LLM associated with the management system 210, which may be or may include an LLM that is based on the transformer model 270 illustrated in FIG. 2D and described in more detail below. The AI architecture 260 may include an input module 262, a preprocessor 264, and a training module 266. Some or all of these modules, which may be referred to as programs, processors, or agents, may be realized based on execution of instructions or data by one or more processors of a computing (or ML) system, such as the computing system 400 of FIG. 4 (described in more detail below).

The input module 262 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 260 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 264 may be equipped with one or more preprocessing algorithms that are configured to prepare input datasets for processing by the training module 266. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 266 may be configured to train and evaluate ML models. As an example, the training module 266 may be configured to perform unsupervised learning and/or supervised learning based in input datasets. In exemplary embodiments, the training module 266 may be capable of training and/or evaluating the performance of multiple models in parallel. In one or more implementations, the training module 266 may, despite operating on multiple ML models in parallel, train and evaluate the various ML models individually. In some implementations, the training module 266 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 260 to train deep learning neural network model(s) to output predictions. Although not shown, the AI architecture 260 may include additional functional modules, such as those for gathering performance results and presenting (e.g., displaying) data regarding the results. While various components, modules, etc. may have been illustrated in FIG. 2C as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 2D, an example transformer model 270 (a portion or an entirety of which may serve as a functional building block of one or more LLMs (e.g., LLM(s) associated with or included in the management system 210, such as the Gen AI model(s) 210m described above with respect to one or more of FIGS. 2A and 2B)) may include an encoder 272 and a decoder 274. The encoder 272 may include an input embedding block 272b, a positional encoder 272c, and a series of (i.e., multiple (Nx)) identical layers that each has a multi-head attention block 272m and a feed forward block 272f. An input (e.g., text, such as a query or a prompt) may be converted into individual tokens (e.g., words, characters, etc.) that are fed into the input embedding block 272b. The input embedding block 272b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 272c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 272b on an element-by-element basis, resulting in a processed input that may be fed into the series of layers. The processed input may be fed into the multi-head attention block 272m in the first layer. An addition (or residual connection) and normalization block 272x may operate on the processed input and the output of that multi-head attention block 272m. The output of the addition and normalization block 272x may be passed to the feed forward block 272f in that layer. An addition and normalization block 272y may operate on the output of the addition and normalization block 272x and the output of the feed forward block 272f. In essence, the multi-head attention block 272m of a given layer may enable the feed forward block 272f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 274 may include an output embedding block 274b, a positional encoder 274c, and a series of (i.e., multiple (Mx)) identical layers that each has a masked multi-head attention block 274k, a multi head attention block 274m, and a feed forward block 274f. An output (shifted right) may be converted into individual tokens that are fed into the output embedding block 274b. The output embedding block 274b may convert the tokens into continuous vectors. The positional encoder 274c may derive fixed positional encodings or learned positional encodings to help capture positional information of tokens. The processed output may be fed into the masked multi-head attention block 274k in the first layer. An addition and normalization block 274w may operate on the processed output and the output of that masked multi-head attention block 274k. The output of the addition and normalization block 274w may be passed to the multi-head attention block 274m in that layer. Output(s) from the encoder 272 may also be fed into the multi-head attention block 274m. An addition and normalization block 274x may operate on the output of the addition and normalization block 274w and the output of multi-head attention block 274m. The output of the addition and normalization block 274x may be passed to the a feed forward block 274f in that layer. An addition and normalization block 274y may operate on the output of the addition and normalization block 274x and the output of the feed forward block 274f. The output of the addition and normalization block 274y may may be passed to a linear layer 274r, which may transform that output into a higher-dimensional space. The output of the linear layer 274r may be fed into a softmax layer 274s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 272 and/or the decoder 274 in particular arrangements and in combination with additional refinements/components. A given LLM constructed as such may then be trained or pre trained (e.g., using the AI architecture 260 of FIG. 2D, a similar AI architecture, a different AI architecture or a combination of some or all of these AI architectures) on a corpus of information and/or finetuned or instruction tuned to analyze/generate data (e.g., text, audio, and/or images).

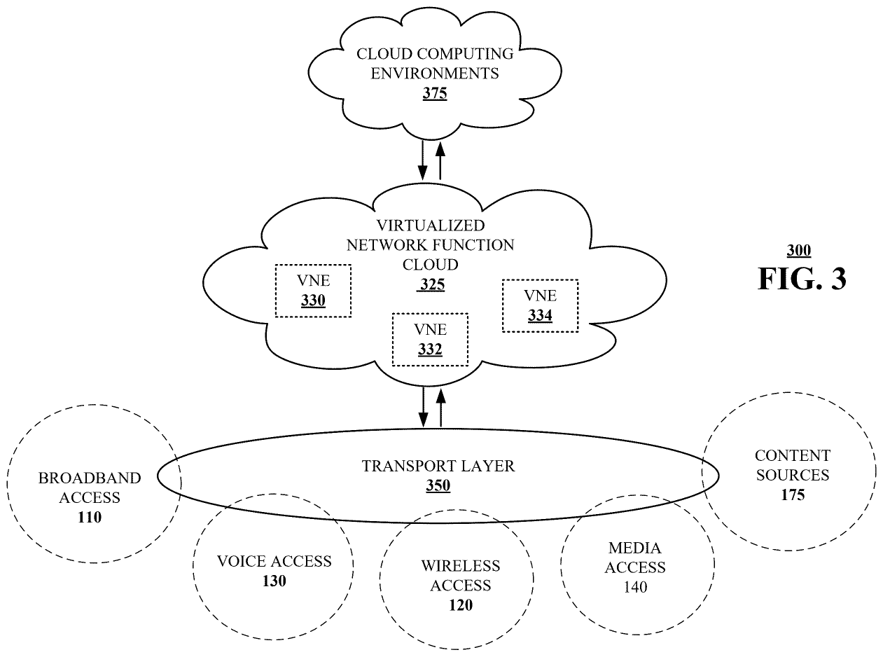

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and method 250 presented in FIGS. 1 and 2A. For example, virtualized communications network 300 can facilitate, in whole or in part, Gen AI-based software/hardware lifecycle management.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers-each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, Gen AI-based software/hardware lifecycle management.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high capacity optical media such as the DVD). The HDD 414, and optical disk drive 420 can be connected to the system bus 408 by a hard disk drive interface 424 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

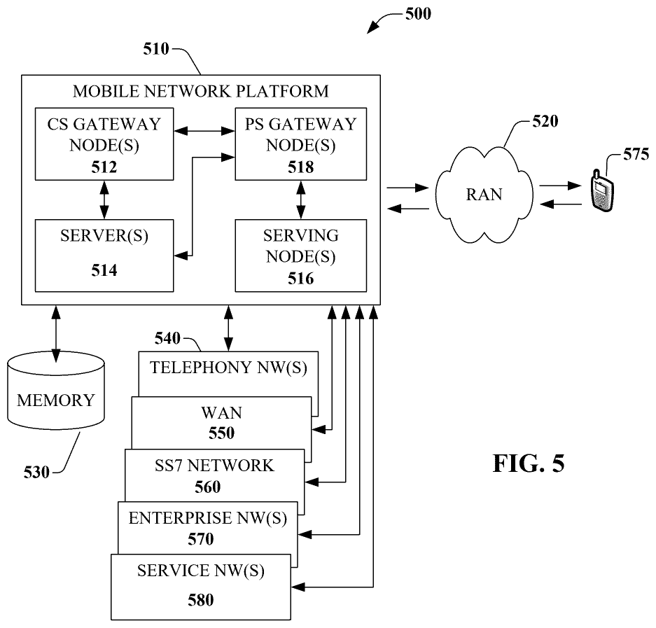

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, Gen AI-based software/hardware lifecycle management. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

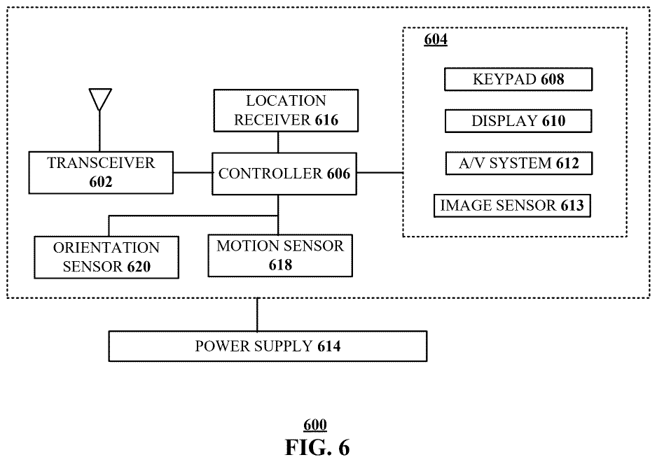

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, Gen AI-based software/hardware lifecycle management.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
obtaining initial information regarding at least one product;
storing the initial information in a data structure;
utilizing at least one artificial intelligence (AI) model to generate first data for supplementing the initial information in the data structure;
conducting automated data extractions from web-based content to obtain second data for further supplementing the initial information in the data structure;
determining an update timeframe for performing additional automated data extractions from web-based content to obtain additional data relating to the at least one product;
conducting the additional automated data extractions from web-based content based on the update timeframe to obtain the additional data relating to the at least one product; and
based on the additional data, performing one or more actions with respect to the data structure or with respect to one or more systems associated with the at least one product.

2. The device of claim 1, wherein the at least one product comprises at least one hardware product, at least one software product, or at least one service.

3. The device of claim 1, wherein the at least one product is provided by a vendor and is utilized by an organization, and wherein the initial information is provided by an individual associated with the organization in relation to a contractual obligation between the vendor and the organization.

4. The device of claim 1, wherein the first data is generated from a knowledge base of the at least one AI model.

5. The device of claim 4, wherein the second data is not within the knowledge base of the at least one AI model.

6. The device of claim 1, wherein the automated data extractions from web-based content comprise web scraping.

7. The device of claim 6, wherein the one or more actions comprise utilizing an AI model to extract information from data obtained via the web scraping.

8. The device of claim 1, wherein the one or more actions comprise detecting a change relating to the at least one product, and based on the detecting the change, triggering an update to the data structure using the additional data.

9. The device of claim 1, wherein the one or more actions comprise detecting an anomaly relating to the at least one product.

10. The device of claim 9, wherein the one or more actions further comprise triggering an alert based on the detecting the anomaly.

11. The device of claim 9, wherein the at least one product comprises a virtual network function (VNF) that is implemented in a radio access network (RAN) or a related network, and wherein the anomaly relates to a security issue with respect to the VNF.

12. The device of claim 11, wherein the one or more actions further comprise causing the one or more systems associated with the VNF to obtain a security patch from a server that is operated by a vendor or a provider of the VNF and to install the security patch to address the security issue.

13. The device of claim 1, wherein the update timeframe is periodic or is based on one or more conditions being satisfied.

14. The device of claim 1, wherein the at least one artificial intelligence (AI) model comprises at least one large language model (LLM).

15. A non-transitory machine-readable medium, comprising executable instructions that, when executed by a processing system including a processor, facilitate performance of operations, the operations comprising:
receiving initial information regarding at least one product or service;
storing the initial information in a data structure;
utilizing at least one artificial intelligence (AI) model to generate first data for supplementing the initial information in the data structure;
conducting automated data extractions from web-based content to obtain second data for further supplementing the initial information in the data structure;
determining an update timeframe for performing additional automated data extractions from web-based content to obtain additional data relating to the at least one product or service;
conducting the additional automated data extractions from web-based content based on the update timeframe to obtain the additional data relating to the at least one product or service; and
based on the additional data, performing one or more actions with respect to one or more systems associated with the at least one product or service.

16. The non-transitory machine-readable medium of claim 15, wherein the one or more actions comprise detecting an anomaly relating to the at least one product or service, wherein the at least one product or service comprises a virtual network function (VNF) that is implemented in a radio access network (RAN) or a related network, and wherein the anomaly relates to a security issue with respect to the VNF.

17. The non-transitory machine-readable medium of claim 16, wherein the one or more actions further comprise causing the one or more systems associated with the VNF to obtain a security patch from a server that is operated by a vendor or a provider of the VNF and to install the security patch to address the security issue.

18. A method, comprising:
utilizing, by a processing system including a processor, at least one artificial intelligence (AI) model to generate first data for supplementing initial information associated with at least one product or service;
conducting, by the processing system, automated data extractions from web-based content to obtain second data for further supplementing the initial information;
determining, by the processing system, an update timeframe for performing additional automated data extractions from web-based content to obtain additional data relating to the at least one product or service;
conducting, by the processing system, the additional automated data extractions from web-based content based on the update timeframe to obtain the additional data relating to the at least one product or service; and
based on the additional data, performing, by the processing system, one or more actions with respect to one or more systems associated with the at least one product or service.

19. The method of claim 18, wherein the one or more actions comprise detecting an anomaly relating to the at least one product or service, wherein the at least one product or service comprises a virtual network function (VNF) that is implemented in a radio access network (RAN) or a related network, and wherein the anomaly relates to a security issue with respect to the VNF.

20. The method of claim 19, wherein the one or more actions further comprise causing the one or more systems associated with the VNF to obtain a security patch from a server that is operated by a vendor or a provider of the VNF and to install the security patch to address the security issue.
